(19) United States
(12) Patent Application Publication
(10) Pub. No.: US 2003/0145498 A1
(43) Pub. Date: Aug. 7, 2003

(54) Portable sign support apparatus

(76) Inventor: Frank Venegas JR., Brighton, MI (US)

Correspondence Address: John G. Posa, Gifford, Krass, Groh, Suite 400, 280 N. Old Woodward Ave., Birmingham, MI, 48009, US

(21) Appl. No.: 09/829,032

(22) Filed: Apr. 9, 2001

(51) Int. Cl. G09F 15/00; F16M 13/00

(52) U.S. Cl. 40/607.1; 248/158

(57) ABSTRACT

An apparatus for use as a portable sign includes a base and an elongated signpost having a plurality of bores holes along its body. The base having a collar portion that includes a bore dimensioned to receive the geometric cross section of the post, and at least one aperture configured to align with the through holes of the elongated signpost. A fastener is received by the aperture and through holes to hold the signpost in one of a plurality of vertical positions.

### FIELD OF THE INVENTION

The present invention relates to an apparatus of a portable sign for use along public highways, and more particularly, to an apparatus having a fill-able body and a removable sign support post for use as a portable sign apparatus.

### BACKGROUND OF THE INVENTION

As the population increases, the need for more vehicles, and new roads for vehicles to travel on, also increases. New road construction, and road maintenance, can create an environment where a portable sign apparatus would be a valuable aid to drivers who, due to the construction activity, seek an alternative route to reach their desired destinations. Also, there are various other temporary situations where an easily assembled, durable, and portable sign apparatus would be useful. These situations could include uses in the directing of pedestrian traffic, for advertising real estate, or for use as distance markers along a marathon route.

Prior art discloses various types of apparatus and assemblies directed toward addressing the above needs and utilities. U.S. Pat. No. 5,220,740 discloses a movable stand having a weighted body member capable of upstandingly receiving a removable signpost. The body member also includes a pair of wheels mounted within its periphery in a fashion that prevents the wheels from contacting the ground when the body member is resting on its bottom portion.

The body member supports a connecting means to receive a stick handle above and generally midway between the wheels. The stick handle allows the body member to be tilted for bringing the wheels in contact with the ground and for moving the body member from one location to another in its tilted position. Although this invention has a means for transporting the apparatus, the body does not provide a convenient means for emptying its contents to enhance portability. Another disadvantage of this apparatus is that it does not provide a convenient and efficient means of storage when the apparatus is not in use.

U.S. Pat. No. 5,860,386 reveals another apparatus for use as a road sign or vehicle barricade. The apparatus has a hollow body member capable of being filled with a liquid ballast material, such as sand or water. The body is disposed with a receiver that can pivotably support an inter-changeable vertical sign having a display area. The apparatus cooperates to hold the sign vertical until overcome by a certain amount and direction of force, at which time the sign pivots down to prevent breakage of the apparatus.

This invention also facilitates a means of disassembly for providing ease and convenience in storage. Despite its features that enhance portability and convenient storage, the sign portion of the apparatus is manufactured to stand vertically at a predetermined height where the present invention is not limited in this manner.

### SUMMARY OF THE INVENTION

The present invention is an apparatus that can be used for a number of different signage purposes such as those needed for construction zones, for directing pedestrian traffic, or for general information display. The portable sign support assembly includes an elongated signpost and a base. The base includes a collar portion that supports a means for fastening the signpost in an upright position and at a desired height.

A preferred embodiment includes a fillable base and an elongated signpost that has a plurality of spaced apart through holes extending along its polygonal shaped body that are capable of slidably receiving a fastener. The fillable base includes a top surface, a bottom portion, and a plurality of sides that define an interior cavity. The bottom portion is adapted to rest on the ground or a generally horizontal surface.

The top surface is disposed with a collar portion that includes a bore and at least one aperture. The aperture is configured to align with the through holes in the signpost. The bore is dimensioned to receive the geometric cross section of the post, and, in the preferred embodiment, allows the base to be filled with a liquid ballast material, such as sand or water.

Further, a fastener is received by the aperture and into one of the plurality of through holes in the post to hold the sign in an upright position. Preferably, the fastener is securely spring mounted within the aperture of the collar portion to prevent loss and prevent vandals from easily removing it. Optionally, in the preferred embodiment, the bottom portion of the fillable base supports a resealable opening for drainage purposes.

In other embodiments the base may support a pair of wheels or grasping handles to enhance portability. Finally, the collar portion of the base may be fashioned to screwably disengage to allow two or more bases to be stacked together for convenient and efficient storage.

### BRIEF DESCRIPTION OF THE DRAWINGS

FIG. 1 is a side elevational view of the portable sign apparatus;

FIG. 1a is a side elevational view of a portable sign support apparatus according to the invention;

FIG. 2 is a cross sectional view a portable sign support apparatus taken along A-A;

FIG. 3 is a view of a wheel assembly disposed along the periphery of the fill-able base;

FIG. 4 is a top view of the fill-able base with the collar portion screw-ably disengaged;

FIG. 4a is a side view of the collar portion screw-ably disengaged;

FIG. 4b is a side view of a stack of fill-able bases with the collar portion screw-ably disengaged;

FIG. 5 is a side elevational view of a portable sign apparatus supporting grasping handles; and

FIG. 5a is a top view of a grasping handle.

### DETAILED DESCRIPTION OF THE INVENTION

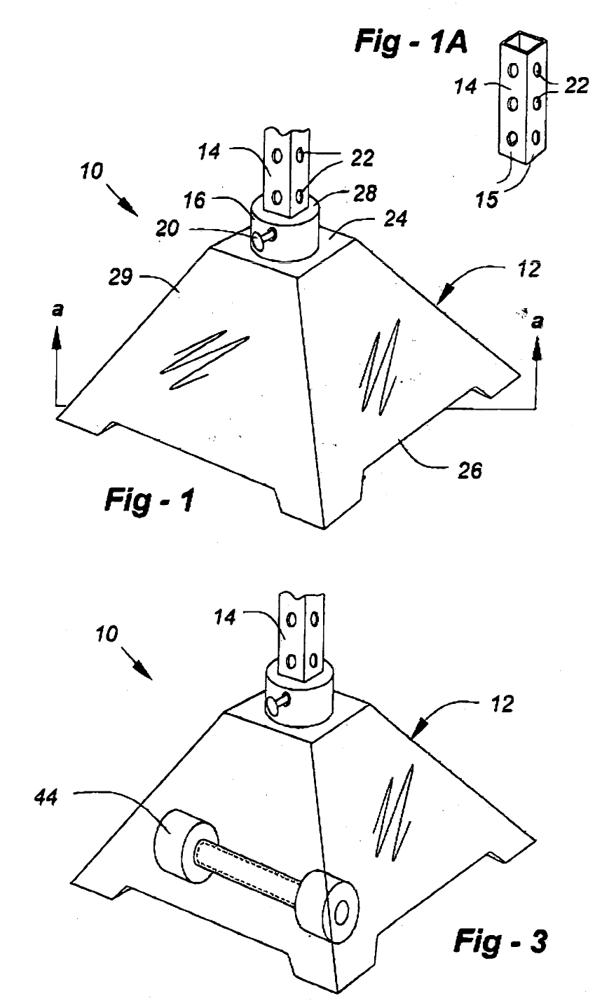

FIG. 1 illustrates a portable sign support apparatus 10 according to the invention that includes a base 12 to receive an elongated signpost 14. The base 12 has a top surface 24, a bottom portion 26, three or more lateral faces 29, and a collar portion 16 with at least one aperture 18 supported between its crown 28 and the top surface 24 of the base 12. The aperture 18 extends through the thickness of the collar portion 16 and is dimensioned to receive a fastener 20. Optionally, the fastener 20 can be securely spring mounted to the collar portion 16 to prevent losing it and to prevent vandals from easily removing it. As a further option, a padlock may be used as the fastener 20, thereby further discouraging tampering.

The body of the elongated signpost 14 has a plurality of through holes 22 that extend along its lateral faces 15 between its two opposite ends (See FIG. 1a). Once the elongated signpost 14 is received into the bore 36 of the collar portion 16, a fastener 20 can slidably engage a through hole 22 in the elongated signpost 14 by traversing the thickness of the collar portion 16 through the aperture 18.

Although the embodiment just described includes a base which is not fillable, or is composed from a solid material such as molded concrete, other embodiments of the invention utilize a hollow base that may be filled with a liquid such as water, or a mixture of liquid and powder or granular material such as sand.

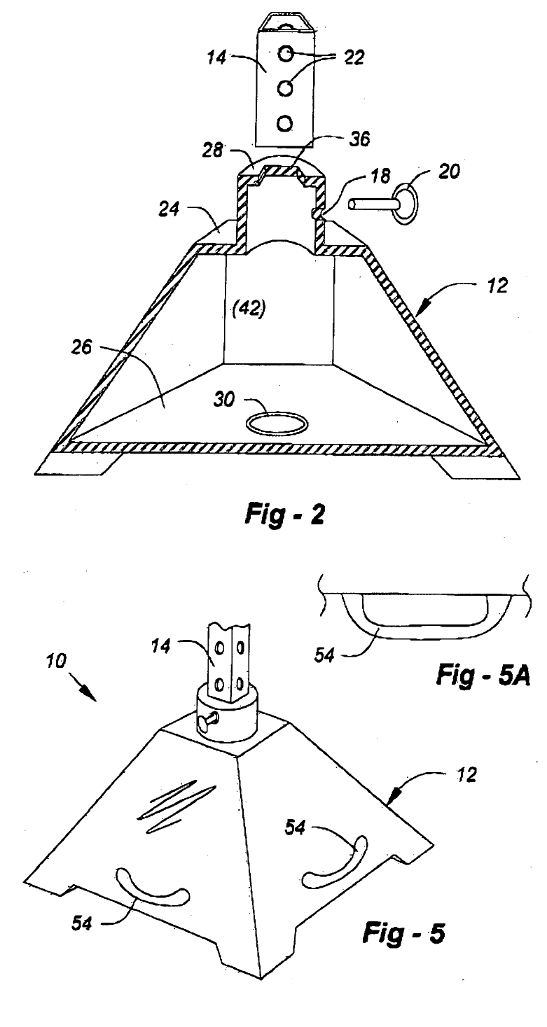

FIG. 2 illustrates a preferred embodiment with a fill-able base 12 having a bottom portion 26 fashioned with a resealable opening 30 for drainage purposes. Alternatively, instead of a separate opening 30, the bore 36 used to receive the sign post 14 may, itself, be used for filling and/or drainage purposes. Indeed, since the base would need to be turned on its side or upside down in order to drain, use of the bore 36 may advantageously prevent inadvertent or intentional but undesired drainage of the base. Optionally, FIG. 3 illustrates a fill-able base 12 with a pair of rolling wheels 44 disposed proximate the periphery of the bottom portion 26. The pair of wheels 44 is positioned so that they are not in contact with the ground surface when the fill-able base 12 rests on its bottom portion 26.

In another embodiment, as shown in FIG. 5, a fill-able base 12 is fashioned with grasping handles 54 supported at the periphery of the bottom portion 26 to enhance portability when the empty.

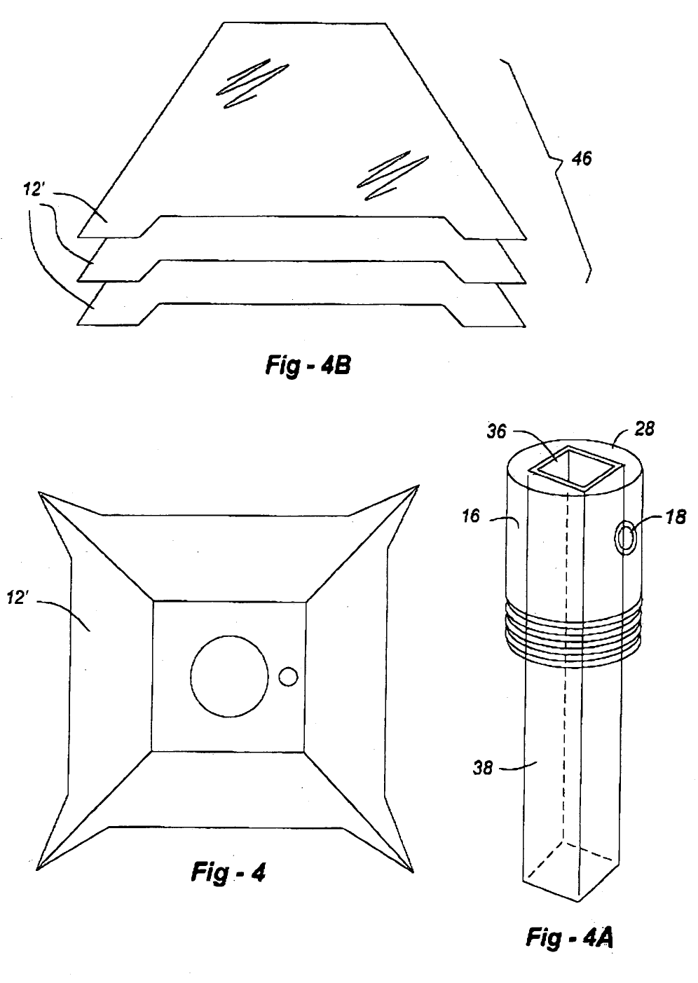

Still further, as shown in FIG. 4, the fill-able base 12′ will support a collar portion 16′ that screwably disengages from the top surface 24. FIG. 4b illustrates how two or more of the fill-able bases 12′ can be stacked together 46 to facilitate efficient storage.

Referring again to FIG. 2, the elongated signpost 14 moves along the path of the direction arrow A and slips into the bore 36 of the collar portion 16. The elongated signpost 14 is aligned and secured at a desired vertical position by slidably inserting the fastener 20 into the aperture of the collar portion 16 and engaging one of the through holes 22 along the body of the signpost 14.

Having described various embodiments of this invention, those skilled in the art will readily conceive various changes and modifications that can be made within the scope and spirit of this invention. Therefore, it is desired that the present invention be limited only by the lawful scope of the following claims.

What is claimed is:

1. A portable sign support apparatus comprised of a base for receiving a sign of the type having an elongated post with a geometric cross section and a plurality of spaced apart through holes, the base comprising:
a body having a bottom portion adapted to rest on the ground and a top surface having a collar:
the collar including a bore dimensioned to receive the geometric cross section of the post and at least one aperture configured to align with the spaced apart through holes of the post when it is received into the collar; and
a fastener received by the aperture and through holes to hold the sign in an aligned, upright position.

2. The portable sign support apparatus of claim 1 wherein the collar portion screw-ably engages the top surface of the base.

3. The portable sign support apparatus of claim 2 wherein the collar portion is disengaged from the top surface of the base.

4. The portable sign support apparatus of claim 3 wherein the base is adapted to stackably receive one or more bases on top of it.

5. The portable sign support apparatus of claim 1 wherein the base has one or more grasping handles disposed near the periphery of the bottom portion.

6. The portable sign support apparatus of claim 1 wherein the base supports a pair of wheels on an axle adjacent and within a portion of its periphery.

7. The portable sign support apparatus of claim 1 wherein the base is fillable with a liquid ballast.

8. The portable sign support apparatus of claim 7 wherein the base is fillable through the bore in the collar portion.

9. The portable sign support apparatus of claim 7 wherein the base has a resealable opening disposed on the bottom portion.

10. The portable sign support apparatus of claim 1 wherein in the fastener is secureably spring mounted within the aperture of the collar portion.
